(19) United States
(12) Patent Application Publication
(10) Pub. No.: US 2010/0052903 A1
(43) Pub. Date: Mar. 4, 2010

(54) Voice recorder based position registration

(75) Inventors: Ankit Tiwari, Farmington, CT (US); Jae-Hyuk Oh, Glastonbury, CT (US); Christian M. Netter, West Hartford, CT (US); Luiz Fer Bacellar, Glastonbury, CT (US); Thomas M. Gillis, Bloomfield, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UTC Fire and Security Corporation, Farmington, CT (US)

(21) Appl. No.: 12/231,473

(22) Filed: Sep. 3, 2008

(51) Int. Cl. G08B 13/00; G10L 15/00

(52) U.S. Cl. 340/541; 704/246

(57) ABSTRACT

A system and method for monitoring a location having at least one sensor for sensing a change in at least one condition using voice tags to announce alarms. The system includes a registration process where a voice recorder and a digital conversion unit form digital voice tags from recorded speech representing the type and location of sensors. The voice tag is sent as part of an alarm message or pre-stored in a control panel for later retrieval such that the type and location of an alarm is reproduced vocally at the time of the alarm. The registration process may be completed with a registration module which may be a keypad or the voice recorder may be included in the sensors. Additional features include sensor location change notification to ensure the stored voice tag represents the current location of the sensor.

### BACKGROUND

The present invention relates to security and fire systems in locations such as buildings. More particularly, the invention relates to a system and method for registering the specific location of at least one sensor for sensing a change in at least one condition.

Security and fire systems are spatially distributed by their very nature. In order for a first responder to locate the sensor when it sends an alarm, it is necessary to register the physical location of all the distributed modules when installing the system. Prior art location registration techniques have been totally manual, where the installer needs to record the physical location of each sensor in the system, either before or after the installation of the module. One prior art system allows the user to walk through a set of pre-recorded voice prompts at the panel to register the sensor. Other systems require manual data entry using small, inconvenient keypads, which is tedious, cost-inefficient, and, most importantly, vulnerable to human errors.

### SUMMARY

A sensor registration process and system is provided for use with fire and security systems where sensors are installed by an installer. The sensor is used to sense a change in at least one condition. In order to be effective, a first responder must be able to quickly determine the location where a sensor raising an alarm is installed. The registration process includes a voice recorder for recording words spoken at the time of installation giving the location of the sensor. Sensor registration includes noting the type of sensor and its location and storing this information to be later recalled and used to identify the specific location of the sensor on the premises. The voice recording is converted to a voice tag via a coder/decoder to send to the control panel using a digital message for storing or to indicate a current alarm if the voice tag is stored in the sensor. When the voice tag is stored in the control panel, the sensor also provides a unique identification number (ID) during the registration process that is stored and associated with the voice tag. The ID is included in the alarm signal and used to retrieve the voice tag associated with the sensor now raising an alarm.

### BRIEF DESCRIPTION OF THE DRAWINGS

FIG. 1 is a block diagram illustrating a fire and security system.

FIG. 2 is a schematic view illustrating the registration of sensors in the system of FIG. 1.

FIG. 3 is a schematic view of a different embodiment not requiring a specific registration module.

FIG. 4 is a schematic view of an embodiment where the voice recorder is separate from the sensor.

FIG. 5 is a schematic view of an embodiment where the voice tag is stored in the sensor.

FIGS. 6 and 7 are side elevation views of an apparatus for use in sensor location change detection.

### DETAILED DESCRIPTION

The present invention provides a system and method for registering a sensor used to monitor a space or location. The sensors may be, by way of example and not of limitation, selected from one or more sensors capable of monitoring motion, smoke, heat, carbon monoxide, water, water vapor, door integrity, window integrity, lock integrity, audio changes, video changes and other activities at a location.

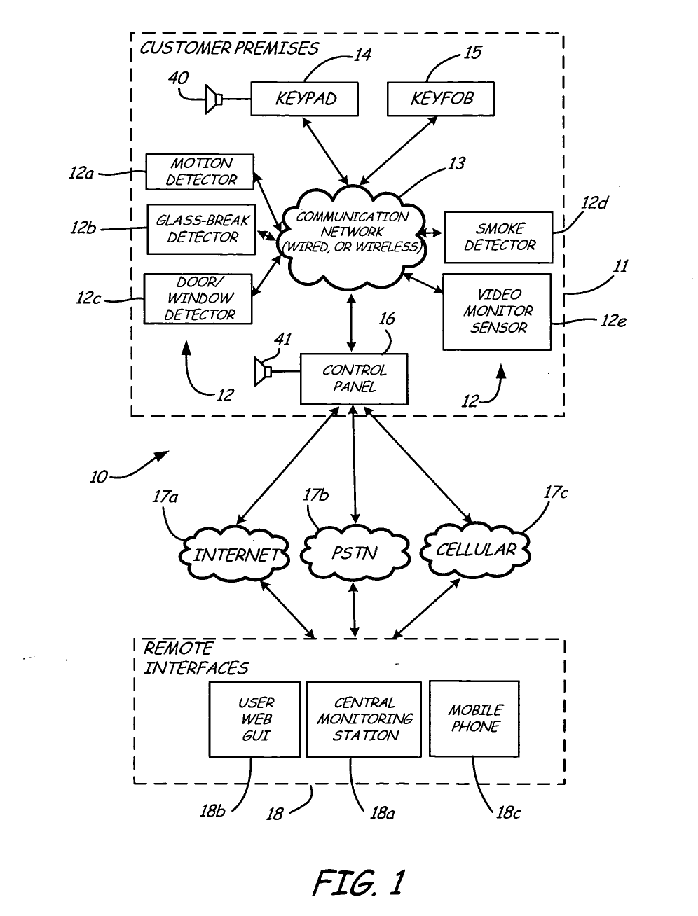

FIG. 1 illustrates fire and security system 10, which is located on premises 11 and which includes a plurality of sensors 12 such as motion detector 12a, glass-break detector 12b, door or window contact sensor 12c, smoke detector 12d, and video monitor 12e. A communication network 13, which is wired or wireless, connects the sensors to control panel 16. Keypad 14 and key fob 15 are examples of devices which allow the user to activate or deactivate the fire and security system. Additionally, keypad 14 contains an encoder/decoder element and transceiver element used to receive digital transmissions of voice tags from control panel 16 and a speaker element to provide spoken identification of the status of the sensors in the system. Keypad 14 can be wireless or hardwired. In some embodiments, keypad 14 is also used as a registration module and carried from one sensor to another during the registration process. Control panel 16 located on premises 11 sends digital signals via internet 17a, land line 17b or cellular network 17c, to a remote location 18 for reception by central monitoring station 18a, user web interface 18b, or mobile phone 18c.

During the use of system 10, when a change occurs in a condition being monitored, sensor 12 associated with that condition sends an alarm signal to control panel 16 which then provides the voice tag associated with the sensor raising the alarm to devices such as keypad 14 on the premises and to remote central monitoring station 18a. It is then relayed to assist first responders such as firefighters and security personnel to locate the sensor and address the change in condition. The voice tag generally includes a pre-recorded portion related to the specific type of sensor 12 and a second portion related to the location recorded during the registration process associated with that sensor. This verbal announcement is made over speakers 40 and 41.

The first task the installer must complete is to prepare system 10 for installation and registration of sensors 12. This process starts by powering up control panel 16. Next, registration module R, which may be keypad 14 in some embodiments, is powered up. Registration module R prompts the user to enter a valid authentication code. Once a valid code is entered, the system is in registration mode. If registration module R is to be permanently installed in the system such as keypad 14, it then prompts the user to record a voice tag describing the keypad's name and location. Registration module R/keypad 14 then transmits its unique identification code, voice tag, and device type information to the control panel to be stored. In some embodiments, control panel 16 includes a speech-to-text element and additionally converts the voice tag to text and stores that as well. With the authentication completed and the keypad 14 registered, sensors 12 can now be registered.

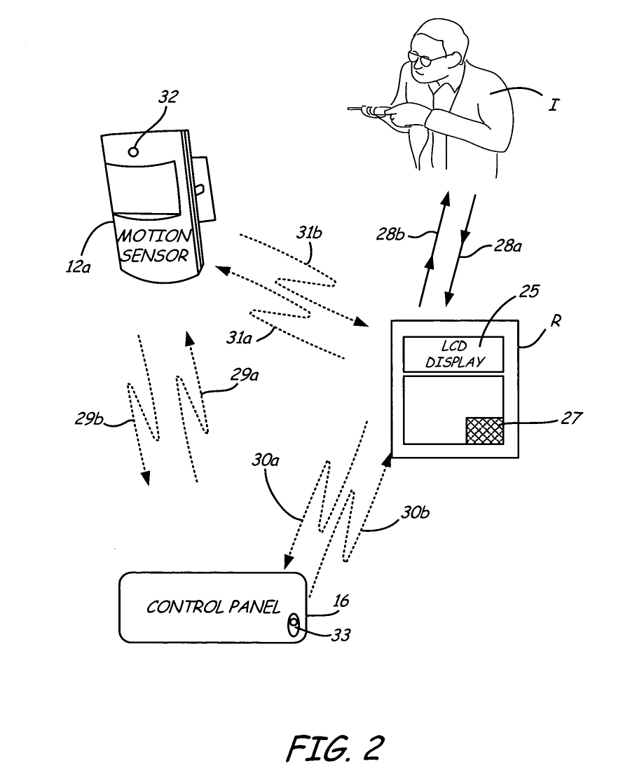

FIG. 2 illustrates the installation and registration process for sensors 12. A procedure for positioning and mounting each sensor 12a-12e is used to insure proper connectivity to control panel 16. First, the coarse location for mounting based upon the sensing requirements selected, ex. the corner of a large room for motion sensor 12a. Using a signal strength indicator on registration module R, such as display 25 of keypad 14, installer I observes the connectivity strength of the network connection to control panel 16 around the selected location. If insufficient or no connectivity is found at the selected mounting location, a repeater, not shown, is installed between the location and control panel 16. Once the connectivity of the location is confirmed, installer I powers up the sensor to be installed at that location.

After installer I selects the mounting location for motion sensor 12a and it is powered up, it sends its unique identification code or ID (that is pre-stored in the sensor or added during mounting) to the registration module via link 31b. Registration module R alerts installer I to the presence of the new device, ex. a “New Device Found” indication on display 25, and provides a prompt for a group number and a voice tag that describes the sensor's location. The group number is used to identify whether sensor 12 is a 24 hour sensor, restoral sensor, etc. The voice tag is generally a phrase such as “dining room window”, “west entry door”, etc and is created by recording the installer's voice spoken into voice recorder 27. An internal or external microphone may be used by voice recorder 27 to make the recording. Registration module R then converts the voice recording using a digital converter to a digital voice tag and sends it, the associated identification code, and the group number to control panel 16 via link 30 to be saved in storage 33. In some embodiments, control panel 16 or registration module R includes a speech-to-text converter element and additionally converts the voice tag to text and stores that as well.

Registration module R then prompts the installer to mount sensor 12a at its desired location and test the connectivity between mounted sensor 12a and the control panel 16. After mounting sensor 12a, installer I uses registration module R to send a test command over link 31a to sensor 12a so that sensor 12a will test its connection to control panel 16. Upon receipt of the test command, sensor 12a then sends a test signal over link 29b to control panel 16. In response to successful signal reception, control panel 16 sends a success signal back to sensor 12a over link 29a. Sensor 12a, upon receipt of the success signal from control panel 16, turns on indicator 32 for communicating the success to installer I. Installer I then repeats the registration process for all remaining sensors 12 (ex. sensors 12b-12e shown in FIG. 1).

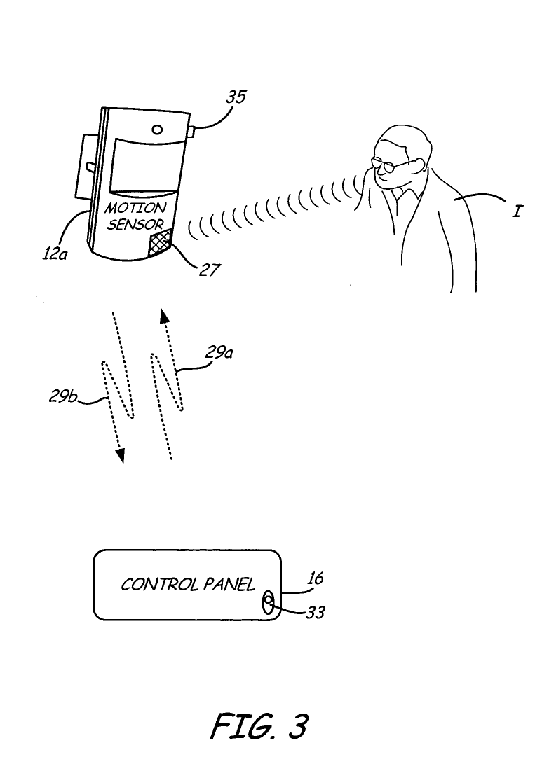

FIG. 3 shows another embodiment that does not require the use of a designated registration module. Each sensor 12 is equipped with voice recorder 27, a digital conversion unit for converting a recorded voice to a voice tag and activation button 35. In the example illustrated, installer I presses activation button 35 on a sensor (ex. sensor 12a shown on FIG. 3) and then speaks the location where sensor 12a is being installed into the sensor's voice recorder 27. The sensor then converts the voice recording to a voice tag and transmits it and its unique identification number using a digital signal to control panel 16 to be saved in storage 33. Sensor 12a is now registered and installer I repeats this process with all other sensors 12b-12e. This process can additionally be repeated during operation with mobile devices such as keyfob 15. For example, the user may create a new voice tag such as “I need help and I'm in the dining room.” This distress call can then be routed to the first responders so that they may provide help quickly.

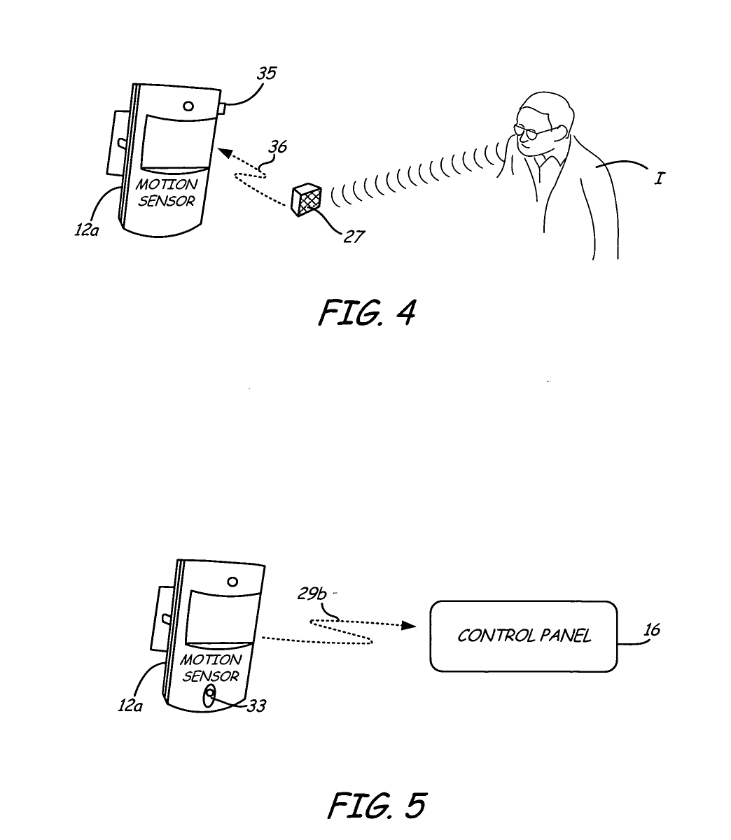

FIG. 4 shows an alternate embodiment where voice recorder 27 may provide the digital voice recording over wired or wireless link 36 to sensor 12a. This embodiment is useful for sensors not equipped with their own voice recorders.

A further embodiment shown in FIG. 5 allows the storage of the voice tag to be located in sensor 12a-12e itself rather than in control panel 16. In this example, sensor 12 transmits the voice tag stored in its memory to control panel 16 at the time of alarm as part of the alarm signal.

Once sensors 12 are installed and registered using the voice tag based registration of the various embodiments, system 10 is ready to operate. When an alarm signal is received from a sensor, such as when smoke is detected, a voice recording is concatenated based on the type of alarm signal. An example is: <PreRecorded_Device_Type_Message> plus <User_Recorded_Voice_Tag>. The prerecorded device type message may be “Motion Detected at” for motion detectors, “Door/Window Open at” or “Door/Window Closed at” for door/window detectors when doors or windows are opened or closed, “Carbon Monoxide Detected at” for carbon monoxide detectors. Control panel 16 plays the concatenated voice recording via speaker 41 or transmits it to keypad 14 to play via speaker 40 to announce the alarm locally. In some embodiments, control panel 16 is additionally capable of leaving a voice message reporting the system alarm to mobile phone 18c or other telephone designated to receive the notice. In embodiments that include video monitoring sensor 12e, control panel 16 can combine the reproduced voice tag and the event related pre-alarm video recording into an audio-video file and send it as an email attachment over the internet or to a mobile phone. Additionally, control panel 16 uses the location text (obtained by speech-to-text conversion) to send an alarm message to a remote interface such as at least one from the following list: a central monitoring station 18a, user web GUI 18b, as an email attachment, to mobile phone 18c, etc. It should be noted that the prerecorded device type message may also be customized by a user in his/her own voice.

System 10 may also include a sensor location change notification. This allows the sensor to notify a user (example: a message on display 25) when the mounting location of an installed and registered sensor is changed. When such a change is detected, the system notifies and prompts the user to change the location related voice-tag so that it corresponds to the new location.

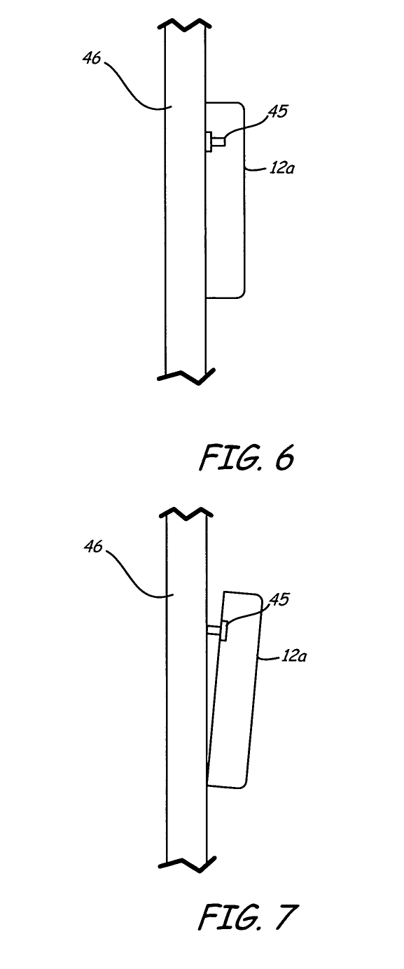

FIGS. 6 and 7 show one procedure to detect a change in mounting location. Sensor 12a has wall-tamper switch 45 in place in FIG. 6 so that when it is dismounted from wall 46, in FIG. 7, the wall-tamper switch is tripped when it breaks contact with the wall. The sensor is then reregistered following the processes outlined above.

Voice generated status messages make system 10 easier to use and understand. The system makes it intuitive for both the user and the first responder to locate the alarm and significantly increases the speed and accuracy of the installation. The user no longer has to go between the selected location and the panel repeatedly or use a small inconvenient keypad in a tedious and error prone process to register the sensor.

Although the present invention has been described with reference to preferred embodiments, workers skilled in the art will recognize that changes may be made in form and detail without departing from the spirit and scope of the invention.

1. A monitoring system comprising:
at least one sensor for sensing a change in at least one condition, the sensor having a unique identification number (ID) and being capable of raising an alarm;
a registration module including a voice recorder for recording a verbal description of the location of the sensor;
a voice to digital conversion unit associated with the voice recorder for creating a voice tag from the verbal description recorded on the voice recorder, the registration module being adapted to send a registration message including the voice tag and the ID associated with the sensor; and
a control panel for receiving the registration message, storing the voice tag and ID, and recalling the ID when the sensor associated with the ID raises the alarm.

2. The system of claim 1, wherein the registration message further comprises a group number.

3. The system of claim 1, wherein the ID is pre-stored in the sensor.

4. The system of claim 1, wherein the condition is selected from the group consisting of motion, smoke, heat, carbon monoxide, water, water vapor, door integrity, window integrity, audio changes, video changes, lock integrity, and location change.

5. The system of claim 1, wherein the system includes a speaker for reproducing the voice tag.

6. The system of claim 1, wherein the control panel or the registration module includes a speech to text converter for storing a text representation of the voice tag.

7. The system of claim 1, wherein the control panel is capable of sending a signal to a remote interface.

8. The system of claim 7, wherein the remote interface includes at least one from the following list: a user web GUI, an email, a central monitoring station, and a mobile phone.

9. The system of claim 4, wherein the sensor, in response to a detected location change, produces a signal indicating that the voice tag associated with the sensor must be updated.

10. The system of claim 1, wherein the voice recorder is connected to the sensor over a wired link.

11. The system of claim 1, wherein the voice recorder is connected to the sensor over a wireless link.

12. The system of claim 1, wherein the alarm includes the message including the voice tag recalled from the storage.

13. The system of claim 1, wherein the control panel includes storage and the transmitter sends the message with the voice tag recorded by the voice recorder to the control panel which stores the message in the storage.

14. The system of claim 13, wherein the sensor further comprises a unique identification number (ID) and the message includes the ID; and wherein the control panel associates the voice tag with the ID.

15. A method comprising:
installing a sensor for sensing a change in at least one condition at a location;
recording words spoken describing the location of the sensor;
converting the recorded words to a voice tag using a voice to digital conversion unit; and
storing the voice tag.

16. The method of claim 15, wherein the method further comprises first testing network signal strength of the location.

17. The method of claim 15, wherein the method further comprises testing the sensor over the network after installing the sensor.

18. The method of claim 15, wherein the condition is selected from the group consisting of motion, smoke, heat, carbon monoxide, water, water vapor, door integrity, window integrity, audio changes, video changes and lock integrity.

19. The method of claim 15, wherein the sensor stores the voice tag.

20. The method of claim 15, wherein storing the voice tag includes the sensor sending the message over the network to a module capable of storing voice.
